(19) United States
(12) Patent Application Publication
(10) Pub. No.: US 2025/0265734 A1
(43) Pub. Date: Aug. 21, 2025

(54) METHOD FOR ENCODING/DECODING DYNAMIC MESH AND RECORDING MEDIUM STORING THE METHOD FOR ENCODING DYNAMIC MESH

(71) Applicant: ELECTRONICS AND TELECOMMUNICATIONS RESEARCH INSTITUTE, Daejeon (KR)

(72) Inventors: Da Yun NAM, Daejeon (KR); Seong Yong LIM, Daejeon (KR)

(21) Appl. No.: 19/058,395

(22) Filed: Feb. 20, 2025

(30) Foreign Application Priority Data
Feb. 20, 2024 (KR) 10-2024-0024621
Feb. 19, 2025 (KR) 10-2025-0021590

(51) Int. Cl. G06T 9/00; G06T 7/10; G06T 17/20

(52) U.S. Cl. CPC G06T 9/001; G06T 7/10; G06T 17/205

(57) ABSTRACT

Provided is a method of decoding a dynamic mesh, which includes decoding a base mesh; subdividing the base mesh; and reconstructing a mesh based on a subdivided mesh. In this instance, a first subdivision method for a subdivision of the base mesh is determined based on subdivision information decoded from a bitstream, and according to a characteristic of a vertex or a vertex group constituting the mesh, it is determined whether the subdivision is performed by a second subdivision method different from the first subdivision method.

### CROSS-REFERENCE TO RELATED APPLICATIONS

This application claims priority under 35 U.S.C. § 119 to Korean Patent Application No. 10-2024-0024621, filed on Feb. 20, 2024, and No. 10-2025-0021590, filed on Feb. 19, 2025, in the Korean Intellectual Property Office, the disclosures of which are incorporated by reference herein in their entireties.

### BACKGROUND OF THE INVENTION

### 1. Field of the Invention

The present disclosure relates to a method of encoding/decoding a dynamic mesh.

### 2. Description of Related Art

Static or dynamic 2D data may generally be encoded/decoded using image or video compression codecs such as AVC, HEVC or VVC. Due to high compression performance of the compression codecs, a method of using the compression codecs to compress immersive video or mesh has continuously been studied.

### SUMMARY OF THE INVENTION

It is an object of the present disclosure to provide a method of subdividing a base mesh generated through mesh decimation.

It is a further object of the present disclosure to provide a method of explicitly encoding/decoding information representing a subdivision method.

It is a further object of the present disclosure to provide a method of implicitly deriving information representing a subdivision method.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of decoding a dynamic mesh, the method including decoding a base mesh; subdividing the base mesh; and reconstructing a mesh based on a subdivided mesh. In this instance, a first subdivision method for a subdivision of the base mesh is determined based on subdivision information decoded from a bitstream, and according to a characteristic of a vertex or a vertex group constituting the mesh, it is determined whether the subdivision is performed by a second subdivision method different from the first subdivision method.

In the method of decoding the dynamic mesh according to the present disclosure, the subdivision information represents a subdivision type index indicating one of a plurality of subdivision type candidates.

In the method of decoding the dynamic mesh according to the present disclosure, the subdivision type candidates comprise at least one of a midpoint subdivision, a loop subdivision, an LS3 (Least Square Subdivision Surfaces), a normal-based subdivision or a PYTHAG subdivision.

In the method of decoding the dynamic mesh according to the present disclosure, the subdivision information represents constitution information of a subdivision mask.

In the method of decoding the dynamic mesh according to the present disclosure, the constitution information comprises at least one of a coefficient of the subdivision mask, a shape of the subdivision mask or a size of the subdivision mask.

In the method of decoding the dynamic mesh according to the present disclosure, the subdivision information represents a subdivision mask index indicating one of a plurality of subdivision mask candidates.

In the method of decoding the dynamic mesh according to the present disclosure, the subdivision mask index is decoded for each of characteristics of a vertex or a vertex group.

In the method of decoding the dynamic mesh according to the present disclosure, the subdivision information further comprises offset information.

In the method of decoding the dynamic mesh according to the present disclosure, a position of a vertex determined by the first subdivision method or the second subdivision method is adjusted by an offset determined by the offset information.

In the method of decoding the dynamic mesh according to the present disclosure, the characteristic comprises a number of dimensions of a vertex, when the number of dimensions of the vertex is three, the vertex is subdivided by the first subdivision method, and when the number of dimensions of the vertex is two, the vertex is subdivided by the second subdivision method.

In the method of decoding the dynamic mesh according to the present disclosure, the characteristic comprises a local shape of a region in which the vertex or the vertex group is included.

In the method of decoding the dynamic mesh according to the present disclosure, the characteristic comprises a type of the vertex, and the type indicates one of a duplicated vertex, a boundary vertex, a degenerated triangle, an intersection vertex or a normal vertex.

In the method of decoding the dynamic mesh according to the present disclosure, when the type of the vertex indicates the normal vertex, the subdivision is performed by the first subdivision method, and when the type of the vertex indicates the duplicated vertex, the boundary vertex, the degenerated triangle or the intersection vertex, the subdivision is performed by the second subdivision method.

In accordance with another aspect of the present disclosure, there is provided a method of encoding a dynamic mesh, the method including generating a base mesh through a mesh decimation; subdividing the base mesh; and encoding the base mesh. In this instance, according to a characteristic of a vertex or a vertex group constituting a mesh, the mesh is subdivided either a first subdivision method or a second subdivision method different from the first subdivision method.

Meanwhile, in the present disclosure, it is possible to provide a computer-readable recording medium recording instructions for implementing the method of encoding/decoding the dynamic mesh.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of an encoder for encoding a dynamic mesh;

FIG. 2 is a block diagram of a decoder for decoding the dynamic mesh;

FIG. 3 is a drawing showing an example of obtaining a subdivided mesh by subdividing a base mesh.

FIG. 4 is a flowchart of a method of encoding a dynamic mesh according to an embodiment of the present disclosure.

FIG. 5 is a flowchart of a method of decoding a dynamic mesh according to an embodiment of the present disclosure.

FIG. 6 illustrates subdivision masks used to determine the position of a new vertex.

FIG. 7 illustrates subdivision masks used to adjust the position of an existing vertex.

FIG. 8 is an example of an intersection vertex among vertex types.

FIG. 9 shows an example of distinguishing between existing vertices and newly generated vertices.

FIG. 10 illustrates vertices located at the boundary of an independent coding unit.

### DETAILED DESCRIPTION OF THE INVENTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. For example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. For example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

A dynamic mesh, which is volumetric media, may be compressed by distinguishing between geometric information and attribute information. Specifically, geometric information and attribute information of the dynamic mesh may be encoded/decoded, respectively. The geometric information may comprise vertexes constituting the dynamic mesh, connecting relationship between vertexes and information on faces. Here, a face may have a triangular shape including three vertices. The attribute information may comprise a normal vector, a texture map mapping coordinate and face attribute information.

The geometric information represents a position of a vertex in a three-dimensional (3D) space and may be encoded/reconstructed through a base mesh and a displacement vector. The attribute information may represent texture, etc.

The attribute information of the dynamic mesh may be encoded/decoded through a general video codec, such as HEVC, VVC, or AV1.

The geometric information of each vertex may be encoded/decoded separately from the attribute information. However, since the number of vertices included in the mesh is significantly large, encoding/decoding thereof without change has a problem of lowering compression efficiency. Accordingly, mesh decimation and mesh subdivision techniques may be applied to encode/decode the geometric information.

FIG. 1 is a block diagram of an encoder for encoding a dynamic mesh.

Referring to FIG. 1, the encoder may include a pre-processing unit 110, a base mesh encoding unit 120, a displacement information encoding unit 130, an image encoding unit 140, and a bitstream generating unit 150.

The pre-processing unit 110 performs mesh decimation on dynamic mesh input. Mesh decimation refers to reducing the number of vertices included in the mesh to reduce the amount of data to be encoded/decoded. Through mesh decimation, a base mesh, which is a basic structure of a mesh, may be generated. That is, the base mesh may have fewer vertices and faces than those of an original mesh. Meanwhile, a vertex included in the base mesh may be referred to as a basic vertex.

However, as the number of vertices included in the mesh decreases, mesh restoration quality in the decoder more deteriorates. To reduce this problem, additional vertices may be generated by applying mesh subdivision technique to the base mesh. A subdivided mesh may include an additional vertex generated through mesh subdivision in addition to basic vertices.

The pre-processing unit 110 may generate an atlas by packing attribute information of each face included in the mesh in a 2D image. Further, the preprocessor 110 may generate mapping information between a face packed in the atlas and a face of the subdivided mesh. Meanwhile, each of faces packed in the atlas may be referred to as a patch.

The pre-processing unit 110 may generate displacement information for the subdivided mesh. The displacement information may include a displacement vector representing a difference between a position of a vertex in the subdivided mesh and a position of a corresponding vertex in a fitted mesh. The fitted mesh may be an approximated one to resemble the original mesh.

The base mesh encoding unit 120, the displacement information encoding unit 130, and the image encoder 140 each encode data generated through the pre-processing unit 110.

Specifically, the base mesh encoding unit 120 encodes the base mesh generated in the preprocessing unit 110.

Meanwhile, the base mesh may be encoded through an intra mode or an inter mode. When the inter mode is applied, a base mesh of a current frame may be derived based on a base mesh of a reference frame. Specifically, by compensating for motion of each vertex in the base mesh of the reference frame, the base mesh for the current frame may be derived.

When the base mesh is encoded in the inter mode, motion information may be encoded and signaled.

The displacement information encoding unit 130 encodes displacement information about vertices included in the subdivided mesh. Here, the displacement information is used to determine a position of a vertex in a 3D space and may include a displacement vector. The displacement vector represents a difference between a current position of a vertex in the subdivided mesh and a position of the corresponding vertex in the fitted mesh.

The image encoding unit 140 encodes attribute information. As an example, the image encoding unit 140 may encode an atlas in which faces of a mesh are packed.

Meanwhile, the displacement information encoding unit 130 and the image encoding unit 140 may operate based on codec technology such as VVC, HEVC, or AV1.

The bitstream generating unit 150 multiplexes the encoded data and generates a bitstream.

Meanwhile, metadata may be generated and encoded so that a reverse process of a preprocessing process performed in the pre-processing unit 110 of the encoder may be performed. The bitstream may further include the metadata.

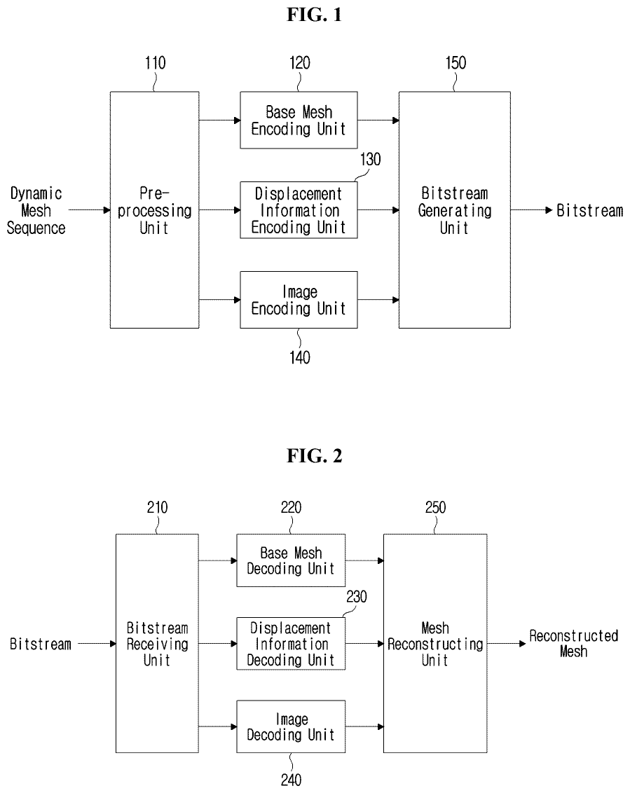

FIG. 2 is a block diagram of a decoder for decoding a dynamic mesh.

Referring to FIG. 2, the decoder may include a bitstream receiving unit 210, a base mesh decoding unit 220, a displacement information decoding unit 230, an image decoding unit 240, and a mesh reconstruction unit 250.

The bitstream receiving unit 210 demultiplexes the received bitstream and derives a plurality of pieces of encoded data. As an example, encoded attribute data, encoded base mesh data, and encoded displacement information may be derived through bitstream demultiplexing.

The base mesh decoding unit 220 decodes the encoded base mesh. Meanwhile, the base mesh may be decoded through the intra mode or the inter mode. When the inter mode is applied, the base mesh of the current frame may be derived based on the base mesh of the reference frame.

The displacement information decoding unit 230 decodes the encoded displacement information. The displacement information is used to determine a position of a vertex in the 3D space and may include a displacement vector.

The image decoding unit 240 decodes the attribute information. As an example, the image decoding unit 240 may decode an atlas in which a plurality of patches is packed.

The mesh reconstruction unit 250 performs mesh subdivision on the decoded base mesh, adds the displacement information to the subdivided mesh, and restores the geometric information of the mesh. In addition, the mesh reconstructing unit 250 may reconstruct the mesh by adding decoded attribute information to the mesh.

As described above, by creating a base mesh through mesh decimation and encoding/decoding the base mesh instead of the original mesh, data that needs to be encoded/decoded may be reduced. However, when the mesh is restored using only the base mesh, a problem occurs in which quality of the restored mesh deteriorates. To prevent the above problem, additional vertices may be generated by performing mesh subdivision on the base mesh. In the decoder, additional vertices may be generated by performing mesh subdivision on the base mesh using the same method as that for the encoder.

As described above, by generating a base mesh through mesh decimation and re-parameterization, and by decoding/decoding the base mesh instead of the original mesh, the data that needs to be decoded/decoded may be reduced. However, when restoring a mesh using only the base mesh, there is a problem that the quality of the restored mesh is degraded. To reduce this problem, additional vertices may be generated by performing subdivision on the base mesh.

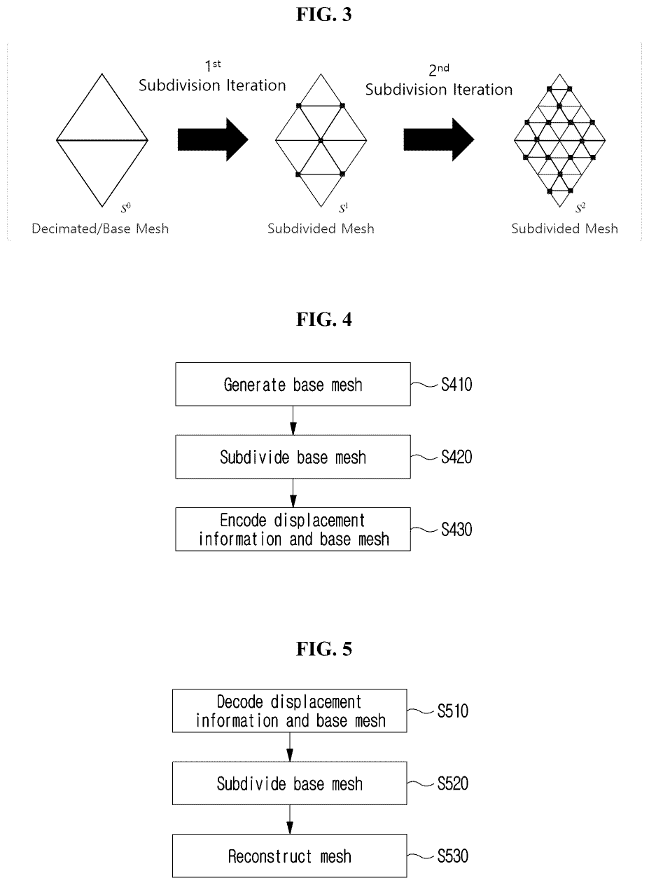

FIG. 3 is a drawing showing an example of obtaining a subdivided mesh by subdividing a base mesh.

Through subdivision, a subdivided mesh with denser vertices and polygonal faces may be generated. By performing subdivision, the surface of the mesh structure may be made smoother and more detailed.

FIG. 3 shows an example of generating a subdivided mesh through two subdivisions.

On the left side of FIG. 3, the base mesh S° generated through mesh decimation, which is a state before subdivision, is shown. On the center of FIG. 3, the subdivided mesh S¹, which has been subdivided once, is shown. A new vertex is added in the middle of the vertexes in the base mesh, and the mesh may have triangle faces with a smaller size than before. On the right side of FIG. 3, the subdivided mesh S², which is a result of performing two subdivisions, is shown. A new vertex is added in the middle of the vertexes of the triangle faces generated from the first subdivision, and S² may have smaller area triangle faces compared to the mesh with the first subdivision.

In each subdivision stage, subdivision is performed on the mesh of the previous step. Accordingly, as the number of subdivision iterations increases, a more detailed and sophisticated mesh structure may be obtained. By additionally applying displacement information to the sub-divided mesh, a mesh closer to the surface of the original mesh may be restored.

The amount of displacement information data required for encoding/decoding varies depending on how similar the result of performing subdivision on the base mesh is to the original mesh. In other words, since the amount of data to be transmitted decreases as the sub-divided mesh is more similar to the original mesh, it is important to improve the encoding performance by making the sub-divided mesh match the original mesh as much as possible through optimal subdivision.

Hereinafter, with reference to FIGS. 4 and 5, a dynamic mesh encoding/decoding method that performs optimal subdivision on a baes mesh will be described in detail.

FIG. 4 is a flowchart of a method of encoding a dynamic mesh according to an embodiment of the present disclosure.

First, the encoder may generate a base mesh S410. As described above, the encoder may generate a base mesh from an original mesh through mesh decimation and re-parameterization.

Next, the encoder may subdivide the base mesh S420. By performing subdivision on the base mesh, additional vertices may be generated. Through subdivision, the mesh may be changed to a dense structure with a larger number of vertices and faces.

The encoder may generate displacement information based on the sub-divided mesh, and encode the displacement information and the base mesh S430.

FIG. 5 is a flowchart of a method of decoding a dynamic mesh according to an embodiment of the present disclosure.

In the decoder, the base mesh and displacement information may be decoded S510. The decoding of the base mesh may be based on the intra mode or the inter mode. In addition, the base mesh may be decoded using a general static mesh codec such as Draco, TFAN, etc.

In the decoder, subdivision for the base mesh may be performed S520. The subdivision may be performed through a subdivision method. The subdivision method may represent a subdivision type or a subdivision mask.

The subdivision method may be determined on a vertex basis or a vertex group basis. Here, a vertex group is a unit including a plurality of vertices. And, the vertex group may include an edge, a face, an edge group, a face group, a segment, a submesh, or a mesh. For example, when the subdivision method is determined in units of vertex group units, for example, in units of meshes, the vertices constituting the mesh may be subdivided through the subdivision method for the mesh.

Meanwhile, the subdivision method may be independently determined for each division iteration.

Thereafter, the decoder may generate a restored mesh using the subdivided mesh and displacement information. Meanwhile, mesh restoration may be to modify the positions of vertices so that the subdivided mesh becomes the same as the original mesh. Mesh restoration may be performed by applying displacement information to the subdivided mesh.

Meanwhile, the decoder must perform subdivision on the base mesh in the same manner as used in the encoder. In order to perform subdivision in the decoder in the same manner as the encoder, the present disclosure proposes the following methods to determine a subdivision method.
1) Explicitly encode mesh subdivision information and transmit it to a decoder
2) Implicitly determine a subdivision method based on vertex characteristics

Meanwhile, the subdivision method may represent a subdivision type or a subdivision mask.

The subdivision type indicates a method of dividing a mesh according to a rule predefined in the encoder and decoder. For example, the subdivision type may include at least one of a midpoint subdivision, a loop subdivision, a butterfly subdivision, an LS3 (Lease Square Subdivision Surfaces), a normal-based subdivision, or a PYTHAG subdivision.

The midpoint subdivision represents a method of generating a center location between two neighboring vertices as an additional vertex.

The loop subdivision represents a partitioning method that adjusts the positions of existing vertices and newly generated vertices. Specifically, when the loop subdivision is applied, the positions of existing vertex (referred to as ‘even vertex’) or newly generated vertex (referred to as ‘odd vertex’) may be derived by a weighted sum operation between the vertex and adjacent vertices. In other words, when the loop subdivision is applied, not only are the positions of newly generated vertices newly determined, but the positions of existing vertices may also be revised.

Meanwhile, when the loop subdivision is applied, a weight mask may be determined according to the characteristics of the vertex. Here, the characteristics of the vertex may be determined by considering at least one of whether the current vertex is an even or odd vertex, or a position of the current vertex. Here, the position of the vertex may refer to a boundary region, an interior region, or an outlier region. The outlier region refers to a region excluding the boundary region and the interior region.

The LS3 may be a method to which a local approximation process for each vertex on a polygonal mesh is added to the midpoint subdivision or the loop subdivision.

The normal-based subdivision may be a process of generating a new vertex at a position where an offset is added to the center of two vertices. At this time, the offset may be set differently depending on the characteristics of the vertex (e.g., normal vector and position of the vertex).

The subdivision mask may represent vertices and weights applied to each of the vertices for determining the position of an existing vertex or a new vertex.

Hereinafter, embodiments of a subdivision method according to the present disclosure will be described in detail.

### Embodiment 1) Explicitly Encoding Subdivision Information and Transmitting it to the Decoder

Subdivision information may be encoded and transmitted to the decoder.

Here, the subdivision information may be subdivision type information.

The subdivision type information may be an index (hereinafter referred to as a subdivision type index) indicating one of a plurality of subdivision type candidates. The plurality of subdivision type candidates may include at least one of a midpoint subdivision, a loop subdivision, a butterfly subdivision, an LS3 (Lease Square Subdivision Surfaces), a normal-based subdivision, or a PYTHAG (Pythagorean means based subdivision) subdivision.

The subdivision type candidate list may include a plurality of subdivision type candidates. At this time, the subdivision type candidate list may be predefined in the encoder and the decoder. The decoder may select one of the subdivision type candidates included in the subdivision type candidate list predefined in the decoder based on the subdivision type information.

Alternatively, configuration information of the subdivision type list may be encoded and signaled. The configuration information may be about at least one of the number or types of subdivision type candidates included in the subdivision type list. The decoder may construct a subdivision type list based on the configuration information, and select one of the subdivision type candidates included in the subdivision type list based on the subdivision type information.

Alternatively, the subdivision information may be information related to a subdivision mask.

The subdivision mask related information may be constitution information of a subdivision mask. The constitution information of a subdivision mask may indicate a weight array or vector data applied to an area formed around a corresponding vertex when updating a position of an existing vertex or generating a new vertex. For example, the constitution information of a subdivision mask may include at least one of a coefficient of the subdivision mask, a shape of the subdivision mask, a size of the subdivision mask, adjacent vertices search process, or an application condition of the subdivision mask.

The subdivision mask may correspond to a subdivision type candidate. For example, a midpoint subdivision mask corresponding to a midpoint subdivision, a butterfly subdivision mask corresponding to a butterfly subdivision, or a loop subdivision mask corresponding to a loop subdivision may be defined.

Alternatively, a customized subdivision mask may be defined. For example, an optimized subdivision mask may be obtained for each input mesh sequence based on a machine vision technique. In the encoder, the subdivision may be applied based on the obtained subdivision mask, and information about the subdivision mask may be encoded and signaled to the decoder. In the decoder, the information about the subdivision mask may be decoded, and then subdivision for the mesh may be performed based on the restored subdivision mask.

Meanwhile, multiple subdivision masks may be used when subdividing the mesh. For example, for each vertex characteristic, subdivision mask related information may be encoded/decoded. Specifically, subdivision mask related information may be encoded/decoded for each of a subdivision mask used to adjust the position of an even vertex and a subdivision mask used to determine the position of an odd vertex.

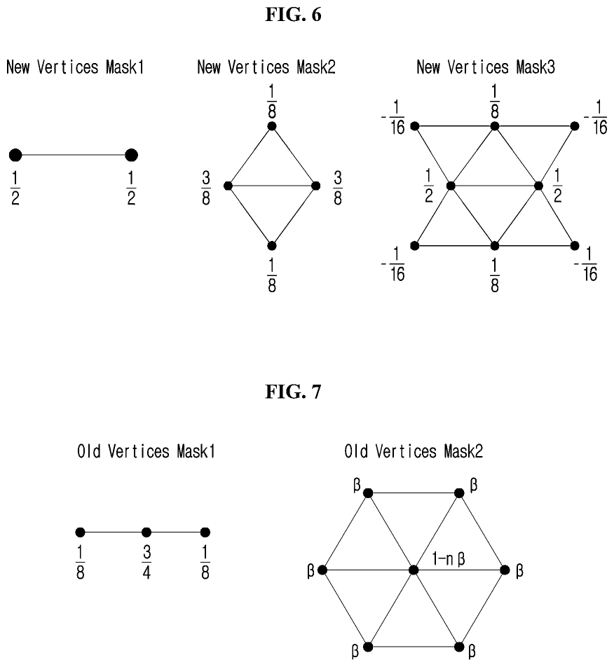

FIG. 6 illustrates subdivision masks used to determine the position of a new vertex, and FIG. 7 illustrates subdivision masks used to adjust the position of an existing vertex.

When multiple subdivision masks are used to subdivide a mesh, subdivision mask related information may be encoded and signaled for each of the multiple subdivision masks. In addition, information indicating the number of subdivision mask related information to be encoded/decoded (i.e., the number of subdivision masks) may also be encoded/decoded.

Meanwhile, multiple subdivision masks may be predefined in the encoder and decoder. For example, in the example illustrated in FIG. 6, subdivision masks for determining the positions of new vertices (i.e., New Vertices Mask1 to 3) may be pre-defined in the encoder and decoder as a single subdivision list, and subdivision masks for adjusting the positions of existing vertices (i.e., Old Vertices Mask1 to 2) may be pre-defined in the encoder and decoder as a single subdivision list.

In this case, the subdivision mask related information may be an index (hereinafter referred to as a subdivision mask index) indicating one of a plurality of subdivision mask candidates included in a subdivision mask candidate list. At this time, at least one of the number of vertices or the weights assigned to each of the vertices may be different between the plurality of subdivision mask candidates.

Meanwhile, a subdivision mask candidate list may exist for each vertex characteristic. In this case, a subdivision mask index for each subdivision mask candidate list may be encoded and signaled. For example, a first subdivision mask index indicating one of the subdivision mask candidates included in a first subdivision mask candidate list for determining a position of a new vertex and a second subdivision mask index indicating one of the mask candidates included in a second subdivision mask candidate list for adjusting a position of an existing vertex may be encoded/decoded, respectively.

Alternatively, regardless of the vertex characteristics, a unified subdivision mask candidate list may be constructed. In this case, for each vertex characteristic, a subdivision mask index indicating one of the subdivision mask candidates included in the unified subdivision mask candidate list may be encoded/decoded. For example, among the subdivision mask candidates included in the unified subdivision mask candidate list, a first subdivision mask index indicating a subdivision mask used to determine a position of a new vertex and a second subdivision mask index indicating a subdivision mask used to adjust a position of an existing vertex may be encoded/decoded, respectively.

The subdivision information may include only one of the subdivision type information and the subdivision mask related information.

For example, subdivision type information (e.g., a subdivision type index) indicating one of the plurality of subdivision type candidates may be encoded and signaled, or subdivision mask related information (e.g., a subdivision mask index) corresponding to each of the plurality of subdivision type candidates may be encoded and signaled.

Meanwhile, in the encoder and decoder, the subdivision mask corresponding to the subdivision type may be stored in advance. Accordingly, when the subdivision type is determined, subdivision for the mesh may be performed using the subdivision mask corresponding to the determined subdivision type.

As another example, depending on the subdivision type, the subdivision mask related information may be additionally encoded/decoded. For example, when the subdivision type information indicates loop subdivision, the subdivision mask related information for the subdivision mask used in the loop subdivision may be additionally encoded/decoded. At this time, the subdivision mask related information for each vertex characteristic may be encoded/decoded.

The subdivision information may further include offset information. When the position of a vertex is determined by the subdivision type or the subdivision mask, the determined position may be adjusted through the offset. The offset information may be transmitted in the form of an array or a single coefficient.

Meanwhile, when multiple subdivision masks are used, the offset may be encoded/decoded for each subdivision mask.

Subdivision information, for example, a subdivision type index or a subdivision mask index, may be explicitly encoded and transmitted to a decoder. At this time, the subdivision information may be transmitted in a unit of a sequence, a frame, an independent coding unit, a subdivision iteration, a vertex, or a vertex group. Here, the independent coding unit may represent a coding unit, a slice, a tile, or a sub-mesh.

Meanwhile, a flag indicating whether the subdivision method is independently determined for each subdivision iteration may be encoded and signaled. If the flag indicates that the subdivision method is independently determined for each subdivision iteration, the subdivision information may be encoded and signaled for each subdivision iteration.

On the other hand, if the above flag indicates that the subdivision method is not independently determined for each subdivision iteration, the subdivision information may be encoded and signaled only for the first iteration. From the second iteration, the subdivision for the mesh may be performed according to the subdivision method determined in the first iteration.

Alternatively, the subdivision information may be encoded/decoded via a SEI (Supplementary Enhanced Information) message or a syntax structure within a dynamic mesh encoding standard specification (e.g., V-DMC).

### Embodiment 2) Implicitly Determining the Subdivision Method Based on a Characteristic of a Vertex

Based on a characteristic of a specific unit, a subdivision method may be adaptively determined. Here, the subdivision method may represent a subdivision type or a subdivision mask.

The specific unit may represent a profile/tier/level, a sequence, a frame, an independent coding unit, a subdivision iteration, a vertex or a vertex group constituting a mesh.

For example, based on a characteristic of a profile/tier/level, a default subdivision method may be adaptively determined. Here, the default subdivision method may represent a default subdivision type or a default subdivision mask.

Alternatively, the default subdivision method may be determined based on a characteristic of an input mesh sequence.

Alternatively, the subdivision method for the mesh corresponding to the mesh frame may be adaptively determined based on a characteristic of an input mesh frame.

Alternatively, when the mesh is divided into independent coding units, the subdivision method may be adaptively determined for each independent coding unit based on a characteristic of each independent coding unit.

Alternatively, the subdivision method may be adaptively determined for each subdivision iteration based on a characteristic of the mesh content inputted or a characteristic of the subdivision method.

Alternatively, the subdivision method may be adaptively determined based on a characteristic of the mesh or a characteristic of the vertex constituting the mesh. Here, the characteristic of the mesh or the vertex may include at least one of the number of dimensions of the vertex coordinates, the number of adjacent vertices, the local mesh shape, or the vertex type.

Depending on the number of dimensions of the vertex coordinates, the subdivision method may be determined.

For example, if the vertex to be processed is two-dimensional, the subdivision type of the vertex to be processed may be determined as a midpoint subdivision, and if the vertex to be processed is three-dimensional, the subdivision type of the vertex to be processed may be determined as a loop subdivision.

For example, if an LS3 requiring three-dimensional operation is selected as the subdivision type, an LS3 subdivision may be applied to three-dimensional vertices, but a midpoint subdivision or a loop subdivision may be applied to two-dimensional vertices.

For example, if a loop subdivision, a normal-based subdivision, or a PYTHAG subdivision is selected as the mesh subdivision type, the selected subdivision type may be applied to three-dimensional vertices, but a midpoint subdivision may be applied to two-dimensional vertices.

Depending on the number of adjacent vertices, the subdivision method may be determined.

For example, if the number of adjacent vertices connected to the currently processed vertex is greater than a threshold, the first subdivision method may be selected, and if not, the second subdivision method may be selected.

Depending on the local mesh shape of the vertex, the subdivision method may be determined. Specifically, depending on a characteristic of the local region including the currently processed vertex and the adjacent vertices, the subdivision method may be adaptively determined.

With respect to the local mesh shape, additional information, including at least one of local curvature, density, sharpness, or saliency, may be derived for the face formed by the currently processed vertex and the adjacent vertices. The above-mentioned additional information may be combined to determine the local mesh shape of the local region to which the currently processed vertex belongs, or to determine whether to deform the local mesh shape of the local region. Here, deforming the local mesh shape may be done by smoothing a curved surface, making a flat surface curved, or making a curved surface more curved.

The local mesh shape may be determined as one of a plurality of shape types. The shape type may include at least one of a plane, a curved surface, an edge, a corner, a noise, or a line/polyline.

Depending on the local mesh shape of the vertex, a subdivision method may be determined.

For example, if the local mesh shape of the region to which the vertex belongs is a first shape type, the first subdivision method may be selected, and if the local mesh shape of the region to which the vertex belongs is a second shape type, the second subdivision method may be selected.

Alternatively, depending on the local mesh shape of the vertex, it may be determined whether to preserve or transform geometry information, and the subdivision method may be determined accordingly. For example, the subdivision type for a vertex that requires preservation of geometric information may be determined as a midpoint subdivision, and the subdivision type for a vertex that requires transformation (e.g., smoothing) of geometric information may be determined as a subdivision type that cause a transformation effect (e.g., loop division).

For example, if the local mesh shape of the region to which the processing target vertex belongs is an edge or corner, the subdivision type may be determined as a midpoint subdivision in order to preserve the geometric information of the processing target vertex.

For example, if the processing target vertex is located on a line (Line/Polyline) rather than a face, the subdivision type may be determined as a midpoint subdivision in order to preserve the geometric information of the processing target vertex.

The subdivision method may be determined according to the vertex type. At this time, the vertex type may be determined based on at least one of geometry information, attribute information, metadata, or information about an independent coding unit.

For example, a vertex type may indicate at least one of whether a vertex is a duplicate vertex, whether a vertex is a boundary vertex, whether a vertex is a part of a degenerate triangle, whether a vertex is a bowtie intersection, or whether a vertex is a normal point (or an abnormal point).

A duplicate vertex indicates a case where two or more vertices are at the same position or very close to each other.

A boundary vertex indicates a case where a vertex is located at the boundary of a specific region.

A degenerate triangle indicates a case where the area of a triangle formed by three vertices is 0 or converges to 0.

An intersection indicates a vertex to which multiple faces are abnormally connected.

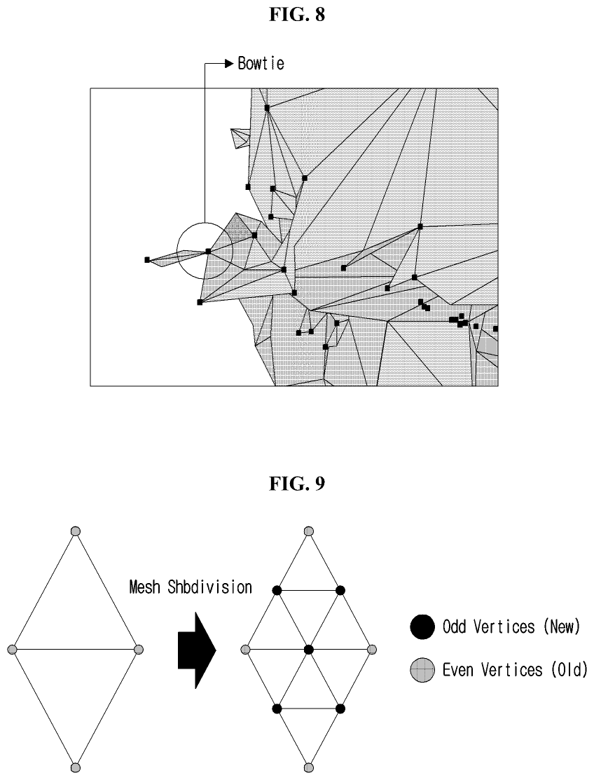

FIG. 8 is an example of an intersection vertex among vertex types.

As in the example illustrated in FIG. 8, if one vertex is a connection point of multiple faces that are not adjacent in a three-dimensional space, the vertex type of the vertex may be an intersection vertex.

Alternatively, the vertex type may indicate whether the vertex currently being processed is an existing vertex or a newly created vertex.

FIG. 9 shows an example of distinguishing between existing vertices and newly generated vertices.

When the structure illustrated in FIG. 9 (a) is subdivided as in FIG. 9 (b) through subdivision, the vertex types of the vertices illustrated in FIG. 9 (a) may indicate existing vertices (i.e., even vertices), and the vertex types of the newly appearing vertices in FIG. 9 (b) may indicate newly generated vertices (i.e., odd vertices).

Alternatively, the vertex type may indicate whether the vertex currently being processed is located at the boundary of an independent coding unit (e.g., the boundary of a coding unit).

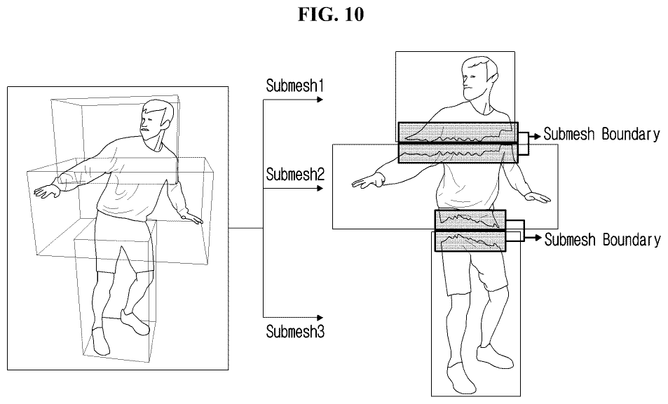

FIG. 10 illustrates vertices located at the boundary of an independent coding unit.

When an independent coding unit is a sub-mesh, the vertex types of the vertices located at the boundary of the sub-mesh may indicate that the vertex is located at the boundary. The vertex types of vertices not located at the boundary of the sub-mesh may indicate that the vertex is not located at the boundary.

An independent coding unit may be a data unit for independently encoding/decoding of mesh data or independently transmitting of mesh data, such as a coding unit, a slice, a tile, or a sub-mesh.

One of the above-described embodiments 1 and 2 may be selectively implemented.

For example, information indicating whether encoding/decoding of subdivision information is skipped or whether it is possible to adaptively determine a subdivision method for each unit may be encoded and signaled. The information may be a 1-bit flag (e.g., subdivision_skip_flag).

If the subdivision information is explicitly encoded/decoded, the subdivision method for the mesh may be determined based on the subdivision information signaled through the bitstream (Embodiment 1).

If encoding/decoding of subdivision information is skipped, the decoder may adaptively determine the subdivision method based on codec characteristics, characteristics of input data, or characteristics of the application (Embodiment 2).

As another example, it may be implemented by combining Embodiment 1 and Embodiment 2.

Specifically, based on the subdivision type information that is explicitly signaled, a subdivision type (hereinafter, a basic subdivision type) for a mesh is determined, and, considering a characteristic of a vertex currently being processed, it is possible to determine whether to apply the basic subdivision type or the basic subdivision mask corresponding to the basic subdivision type to the vertex or the vertex group currently being processed. Here, the characteristic of the vertex may include at least one of the number of dimensions of the vertex, the number of adjacent vertices of the vertex, the local mesh shape of the vertex, or the type of the vertex. In addition, the basic subdivision mask, which is corresponding to the basic subdivision type, may be predefined in the encoder and decoder.

For example, when the basic subdivision type is a loop subdivision, it is possible to determine whether to apply the basic subdivision type (or the basic subdivision mask) as it is, depending on whether the vertex currently being processed is located on the boundary of an independent coding unit.

If the vertex currently being processed is not located on the boundary of an independent coding unit (e.g., a sub-mesh), mesh subdivision may be performed using the basic subdivision type (or the basic subdivision mask). Conversely, if the vertex currently being processed is located on the boundary of an independent coding unit (e.g., a sub-mesh), mesh subdivision may be performed using a subdivision type different from the basic subdivision type (or a subdivision mask different from the basic subdivision mask) to preserve geometric information.

Or, if the vertex type indicates a normal point, the subdivision may be performed using the basic subdivision type (or the basic subdivision mask).

On the other hand, if the vertex type indicates an overlapping point, a boundary point, a degenerate triangle, or an intersection point, the subdivision may be performed using a subdivision type different from the basic subdivision type (or a subdivision mask different from the basic subdivision mask). Meanwhile, a subdivision type different from the basic subdivision type may be a default subdivision type predefined in the encoder and decoder. For example, the default subdivision type may be a midpoint subdivision.

Alternatively, the default subdivision type may be adaptively determined based on the basic subdivision type or a characteristic of a vertex.

In addition, a subdivision mask different from the basic subdivision mask may be a default subdivision mask predefined in the encoder and decoder. That is, information related to the configuration of the default subdivision mask may be predefined in the encoder and decoder.

Alternatively, when multiple subdivision masks are defined for one subdivision type, the subdivision mask may be adaptively determined based on a characteristic of a vertex or a vertex group.

As an example, for a loop subdivision, it is assumed that a first subdivision mask and a second subdivision mask are predefined. In this case, the first subdivision mask and the second subdivision mask may be selectively used based on a characteristic of a vertex. For example, for a newly generated vertex, the subdivision may be performed using the first subdivision mask, and for an existing vertex, the subdivision may be performed using the second subdivision mask.

Meanwhile, instead of determining the basic subdivision type based on the subdivision information, the default subdivision type predefined in the encoder and decoder may be used as the basic subdivision type. For example, if a flag (e.g., subdivision_skip_flag) indicates that encoding/decoding of the subdivision information is omitted, the default subdivision type predefined in the encoder and decoder may be set as the basic subdivision type.

Meanwhile, based on the selected subdivision method, parameters/formulas for transform and/or quantization may be adaptively selected/adjusted. In addition, a flag indicating whether information about the subdivision method may be referenced during the transform and/or quantization process may be encoded and signaled.

According to the present disclosure, there is an effect of improving objective/subjective image quality with reducing amount of data to be encoded/decoded by providing a method of subdividing a base mesh generated by a mesh decimation.

According to the present disclosure, a method to explicitly encode/decode information related to the subdivision method is provided.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of decoding a dynamic mesh, comprising:
decoding a base mesh;
subdividing the base mesh; and
reconstructing a mesh based on a subdivided mesh,
wherein a first subdivision method for a subdivision of the base mesh is determined based on subdivision information decoded from a bitstream, and
wherein, according to a characteristic of a vertex or a vertex group constituting the mesh, it is determined whether the subdivision is performed by a second subdivision method different from the first subdivision method.

2. The method of claim 1, wherein the subdivision information represents a subdivision type index indicating one of a plurality of subdivision type candidates.

3. The method of claim 2, wherein the subdivision type candidates comprise at least one of a midpoint subdivision, a loop subdivision, an LS3 (Least Square Subdivision Surfaces), a normal-based subdivision or a PYTHAG subdivision.

4. The method of claim 1, wherein the subdivision information represents constitution information of a subdivision mask.

5. The method of claim 4, wherein the constitution information comprises at least one of a coefficient of the subdivision mask, a shape of the subdivision mask or a size of the subdivision mask.

6. The method of claim 1, wherein the subdivision information represents a subdivision mask index indicating one of a plurality of subdivision mask candidates.

7. The method of claim 6, wherein the subdivision mask index is decoded for each of characteristics of a vertex or a vertex group.

8. The method of claim 1, wherein the subdivision information further comprises offset information.

9. The method of claim 8, wherein a position of a vertex determined by the first subdivision method or the second subdivision method is adjusted by an offset determined by the offset information.

10. The method of claim 1, wherein the characteristic comprises a number of dimensions of a vertex,
wherein when the number of dimensions of the vertex is three, the vertex is subdivided by the first subdivision method, and
wherein when the number of dimensions of the vertex is two, the vertex is subdivided by the second subdivision method.

11. The method of claim 1, wherein the characteristic comprises a local shape of a region in which the vertex or the vertex group is included.

12. The method of claim 1, wherein the characteristic comprises a type of the vertex, and wherein the type indicates one of a duplicated vertex, a boundary vertex, a degenerated triangle, an intersection vertex or a normal vertex.

13. The method of claim 12, wherein:
when the type of the vertex indicates the normal vertex, the subdivision is performed by the first subdivision method, and
when the type of the vertex indicates the duplicated vertex, the boundary vertex, the degenerated triangle or the intersection vertex, the subdivision is performed by the second subdivision method.

14. A method of encoding a dynamic mesh, comprising:
generating a base mesh through a mesh decimation;
subdividing the base mesh; and
encoding the base mesh,
wherein, according to a characteristic of a vertex or a vertex group constituting a mesh, the mesh is subdivided either a first subdivision method or a second subdivision method different from the first subdivision method.

15. A non-transitory computer readable medium storing program instruction when executed cause a computer to carry out a method of encoding a dynamic mesh, the method comprising:
generating a base mesh through a mesh decimation;
subdividing the base mesh; and
encoding the base mesh,
wherein, according to a characteristic of a vertex or a vertex group constituting a mesh, the mesh is subdivided either a first subdivision method or a second subdivision method different from the first subdivision method.
